(19) United States
(12) Patent Application Publication
(10) Pub. No.: US 2008/0059175 A1
(43) Pub. Date: Mar. 6, 2008

(54) Voice recognition method and voice recognition apparatus

(75) Inventor: Takayuki Miyajima, Anjo (JP)

Correspondence Address: OLIFF & BERRIDGE, PLC, P.O. BOX 320850, ALEXANDRIA, VA, 22320-4850, US

(73) Assignee: AISIN AW CO., LTD., ANJO-SHI (JP)

(21) Appl. No.: 11/889,047

(22) Filed: Aug. 8, 2007

(30) Foreign Application Priority Data
Aug. 29, 2006 (JP) 2006-232488

(51) Int. Cl. G10L 15/00

(52) U.S. Cl. 704/246; 704/E15.001

(57) ABSTRACT

Systems and methods store groups of recognition candidates respectively associated with visual target objects located around a speaker. The systems and methods detect a direction of a sight line of the speaker or a movement by the speaker. The systems and methods determine one of the visual target objects on the basis of the direction of the sight line or the movement. The systems and methods set, from among the recognition candidates in the recognition dictionary, each of the recognition candidates associated with the determined visual target object as a recognition target range, and from among the recognition target range, select a recognition candidate which is highly similar to voice data inputted by a microphone.

### INCORPORATION BY REFERENCE

The disclosure of Japanese Patent Application No. 2006-232488, filed on Aug. 29, 2006, including the specification, drawings and abstract thereof, is incorporated herein by reference in its entirety.

### BACKGROUND

1. Related Technical Fields

Related technical fields include voice recognition methods and a voice recognition apparatuses.

2. Related Art

Navigation systems with voice recognition capabilities have been proposed to assist in safer driving. In such systems, voice signals inputted from a microphone go through a recognition process and are converted into character series data. The character series data is used as a command to control various apparatuses such as an air conditioner. It may be difficult to perform accurate recognition when there are a lot of background noises inside of a vehicle such as an audio sound, noises made during driving and so forth. Accordingly, when a driver speaks a geographical name, the navigation system may collate detected recognition candidates on the basis of the voice recognition and geographical name data such as “prefecture name” or “city (or any local) name” in stored map data. When the geographical name data and the recognition candidates are matched, the recognition candidate is recognized as a command to specify a geographical name. See Japanese Unexamined Patent Application Publication No. JP A 2005-114964

### SUMMARY

According to the system described above, the accuracy of the recognition of a geographical name may be improved. However, when a vocal order such as “turn up the temperature,” or the like, is spoken for an air conditioner, for example, the accuracy of the recognition of the voice command may not improve. That is, voice commands for items other than geographical names is not improved.

Accordingly, exemplary implementations of the broad principles described herein provide a voice recognition method and a voice recognition apparatus for improving the accuracy of the recognition.

Various exemplary implementations provide voice recognition systems and methods that store groups of recognition candidates respectively associated with visual target objects located around the speaker. The systems and methods detect a direction of a sight line of the speaker or a movement by the speaker. The systems and methods determine one of the visual target objects on the basis of the direction of the sight line or the movement. The systems and methods set, from among the recognition candidates in the recognition dictionary, each of the recognition candidates associated with the determined visual target object as a recognition target range, and from among the recognition target range, select a recognition candidate which is highly similar to voice data inputted by a microphone.

### BRIEF DESCRIPTION OF THE DRAWINGS

Exemplary implementations will now be described with reference to the accompanying drawings, wherein:

FIG. 1 shows an exemplary navigation system;

FIG. 2 shows an exemplary position of an equipped camera;

FIG. 3 shows each position of an eyeball when a sight line moves to a) front, b) lower right, c) left, and d) lower left;

FIG. 4 shows each position of an exemplary target apparatus;

FIG. 5 is an exemplary table of target apparatus selection;

FIG. 6 is a diagram showing a part of a data structure of an exemplary recognition dictionary;

FIG. 7 is a flowchart showing an exemplary recognition method; and

FIG. 8 is a flowchart showing an exemplary recognition method.

### DETAILED DESCRIPTION OF EXEMPLARY IMPLEMENTATIONS

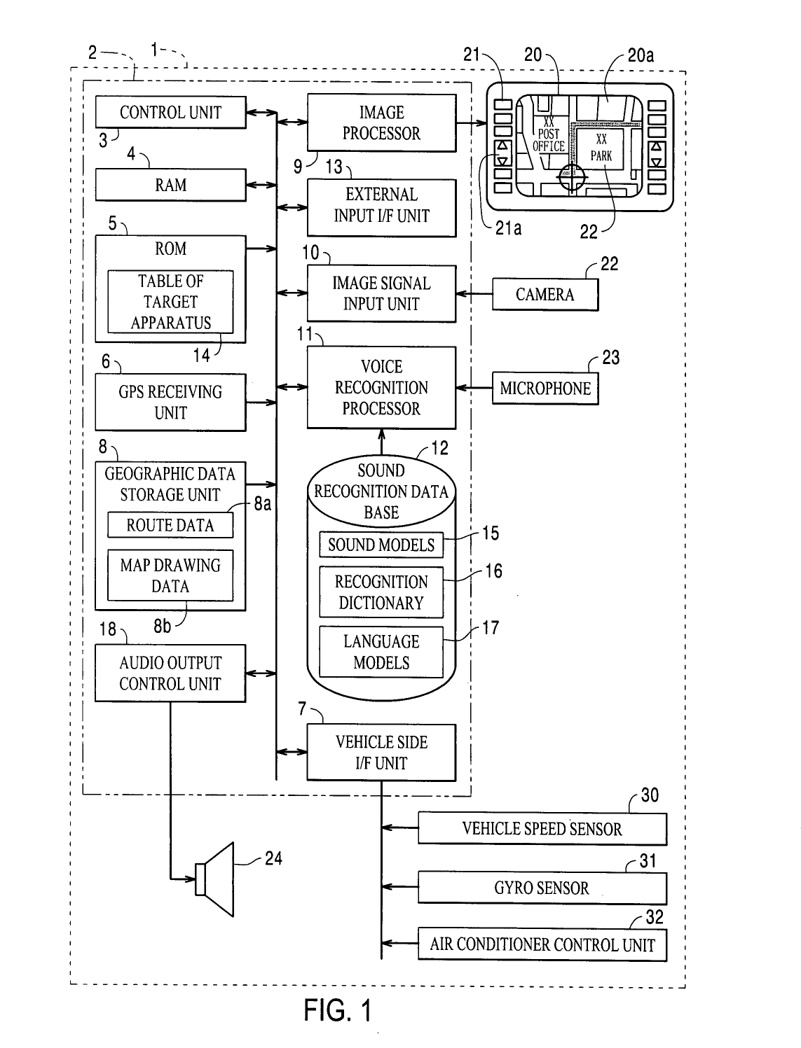

FIG. 1 is a block diagram illustrating an exemplary structure of a navigation system 1 mounted in an automobile (a vehicle), which may be used, for example, as a visual target object and a control target apparatus. As shown in FIG. 1, the navigation system 1 may include a control apparatus 2 serving as a voice recognition apparatus for processing a voice recognition and so forth. The navigation system 1 may include a display 20 serving as a visual target object and a control target apparatus for displaying various screens. The navigation system 1 may include a camera 22 serving as a filming means, a microphone 23 serving as a voice input means, and a speaker 24.

The control apparatus 2 may include a controller (e.g., control unit 3) serving as a sight line detecting means, a sight line determining means, and a vehicle-side control means. The control apparatus 2 may include a RAM 4 for temporarily storing the computed result performed by the control unit 3. The control apparatus 2 may include a ROM 5 for storing various programs such as a route searching program, a voice recognition program and so forth. The control apparatus 2 may include and a GPS receiving unit 6.

The control unit 3 may include an LSI circuit or the like and may calculate the absolute coordinate that indicates the position of the vehicle based on a position detecting signal inputted by the GPS receiving unit 6. Further, the control unit 3 may calculate a relative position based on a reference position by inputting a vehicle speed pulse and a direction detecting signal by a vehicle speed sensor 30 and a gyro sensor 31 through a vehicle-side I/F unit 7 of the control apparatus 2. Subsequently, the control unit 3 may sequentially specify the position of the vehicle in response to the absolute coordinate on the basis of the GPS receiving unit 6.

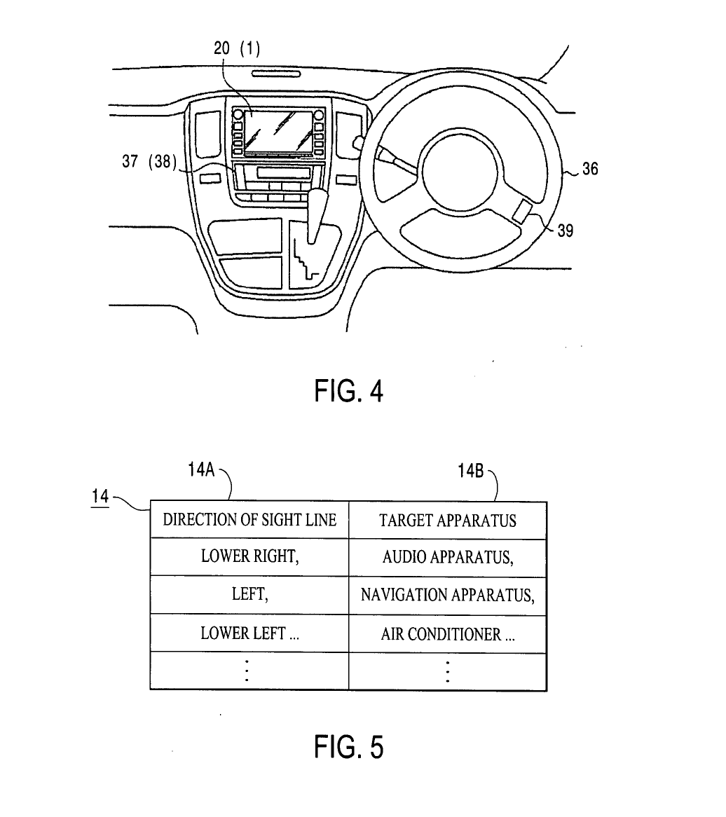

The control unit 3 may send and receive various signals to/from an air conditioner control unit 32 through the vehicle-side I/F unit 7. The air conditioner control unit 32 may controls an air conditioner 38 (see FIG. 4) based on manual operation or by the result of voice recognition by the control apparatus 2. Such controls may include, e.g., a temperature adjustment, an air volume adjustment, a mode change, and so forth.

When a button 21 placed around the display 20 is operated, an external input I/F unit 13 may output the signal based on the operation to the control unit 3 or an audio output control unit 18. For example, when a button 21 for activating an audio music is operated, the audio output control unit 18 may read musical files from music database or an external storage apparatus equipped in the navigation system 1, or may control a radio tuner to output the audio through the speaker 24. When a button 21a for audio-volume adjustment is operated, the audio output control unit 18 also adjusts the volume of the audio outputted from the speaker 24 corresponding to the operation.

As shown in FIG. 1, the control unit 2 may include a geographical data storage unit 8 and an image processor 9 serving as a sight line detecting means. The geographical data storage unit 8 may serve as an external storage medium such as a hard disk or an optical disk. The geographical data storage unit 8 may store route data 8a for searching for a route to a destination and map drawing data 8b for outputting a map screen 20a on the display 20.

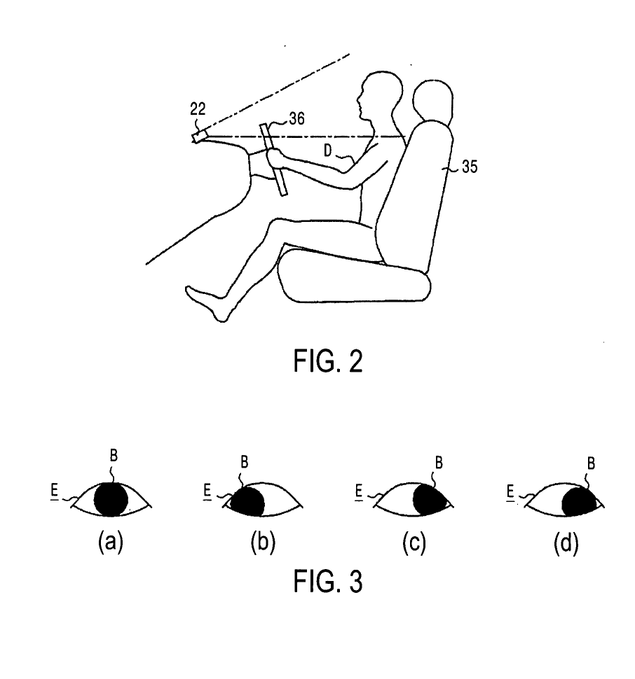

The image processor 9 may input the image data from the camera 22 equipped in the vehicle through an image signal input unit 10 and may detect the direction of the sight line of the driver (i.e., the speaker). The camera 22 may thus locate a position of the driver's eyes. As shown in FIG. 2, the camera 22 may locate around a combination-meter or a steering wheel 36. The camera 22 may film mainly the head of a driver D sitting on a driver's seat 35 and may output the image signal to the image signal input unit 10. The image signal input unit 10 may generate the image data from the image signal through, for example, A/D conversion and may output the image data to the image processor 9. The image processor 9 may perform image processing of the image data and may detects the position of an eyeball B of driver D's eye E (see FIG. 3(a)). Note that the camera 22 itself may also/alternatively perform A/D conversion of the image signal.

Subsequently, the image processor 9 may input the image data at predetermined intervals and may monitor the change of the position of the eyeball B of the eye E. When the sight line of the driver D moves from the front to the lower right (viewed from the driver's side), the image processor 9 may analyze the image data and calculates the new position of the eyeball B. When the position of the eyeball B is calculated, the image processor 9 may output the analyzed result to the control unit 3. The control unit 3 may then determine the direction of the sight line of the driver D based on the analyzed result.

FIG. 3(a) through (d) are the diagrams illustrating positions of the eyeball B of one eye. For example, as shown in FIG. 3(b), when the analyzed result is outputted showing that the position of the eyeball B locates at the lower right, the control unit 3 may determine that the direction of the sight line of the driver D is the lower right. Also, as shown in FIG. 3(c), when the analyzed result may be outputted showing that the position of the eyeball B locates at the left side, the control unit 3 determines that the direction of the sight line of the driver D is the left. Further, as shown in FIG. 3(d), when the analyzed result may be outputted showing that the position of the eyeball B locates at the lower left, the control unit 3 determines that the direction of the sight line of the driver D is the lower left.

On the basis of the detected direction of the sight line and a table of the target apparatus selection pre-stored in ROM 5 (see FIG. 1 and FIG. 5), the control unit 3 predicts the apparatus that the driver D is looking at. As shown in FIG. 5, in the table of the target apparatus selection 14a, the direction of the sight line of the driver D 14a may be associated with a target apparatus 14b as a category. For example, as shown in FIG. 4, in case the direction of the sight line 14a is “lower right,” an audio button 39 located at the lower right from may be the visual target, and thus “audio apparatus” is predicted as the target apparatus 14b.

Also, in case the direction of the sight line 14a is “left,” there is high possibility that the driver D is looking at the display 20 in the navigation system 1 located on the left, and thus “navigation system” is predicted as the target apparatus 14b. Similarly, when the direction of the sight line 14a is “lower left,” there is a high possibility that the driver D is looking at the control panel 37 of the air conditioner 38, and thus “air conditioner” is predicted as the target apparatus 14b. Note that the direction of the sight line 14a may be the data corresponding to the coordinate of the eyeball B instead of the data corresponding to directions such as “lower right,” “left,” or the like. The target apparatus 14b determined as above will then be used for a voice recognition of the driver D.

The voice recognition processing may be performed by means of a voice recognition processor 11 (see FIG. 1) which may work mainly as a range setting means and a recognition means based on a voice recognition database (hereinafter referred to the voice recognition DB 12). The voice recognition processor 11 may incorporate an interface for inputting the voice signal (voice data) from the microphone 23 equipped in the vehicle (see FIG. 1), an LSI circuit for a voice recognition and so forth. The microphone 23 may be equipped around the driver's seat 35 and may input the voice spoken by the driver.

The voice recognition DB 12 may store sound models 15, a recognition dictionary 16, and language models 17. The sound models may be the data in which the feature amount and the phonemes of the voice are associated. The recognition dictionary 16 may store tens to hundreds of thousands of words corresponding to the phoneme series. The language models 17 may be the data which models the probability for words to position at the beginning or the end of sentences, the probability of connection between a series of words, modifying relationships, and so forth.

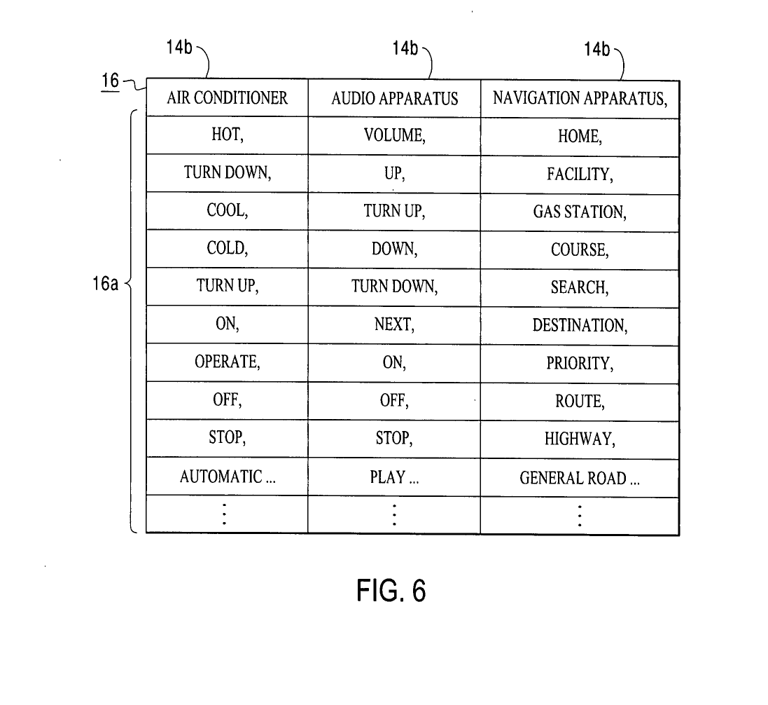

FIG. 6 is a diagram illustrating a part of the structure of an exemplary recognition dictionary 16. As shown in FIG. 6, recognition candidates 16a stored in the recognition dictionary 16 may be grouped by the target apparatuses 14b and are the words relating to the operation on each target apparatus 14b.

The voice recognition processor 11 may calculate the feature of the wave of an inputted voice signal. Then the calculated feature amount may be collated with the sound models 15 to select the phonemes corresponding to the feature amount such as “a” or “tsu.” However, even when the driver D was supposed to pronounce “atui,” due to the individual's pronouncing habit, not only the phoneme series “atui” but also other similar phoneme series such as “hatsui” or “asui” may be detected. Further, the voice recognition processor 11 may collate these detected phoneme series with the recognition dictionary 16 to select the recognition candidates.

However, when the control unit 3 assumes the target apparatus 14b that the driver D is looking at is “air conditioner,” the voice recognition processor 11 may narrow down to only the recognition candidates 16a that relate to the “air conditioner” from among of the original recognition candidates 16a. Then only the narrowed recognition candidates 16a may be determined to be the recognition target range. Subsequently, each of the recognition candidates 16a within the recognition target range and each of the phoneme series calculated on the basis of the sound models 15 may be collated to calculate the similarity, and the recognition candidate 16a, which has highest similarity, is determined. By setting the recognition target range as described above, the recognition candidates 16a that have low possibility to be a target even with a similar sound feature may be excluded, and the accuracy of the recognition may improve accordingly.

The voice recognition processor 11 may calculate the probability of connecting relations between a series of words using the language models 17 and may determine the consistency. For example, when a plurality of words are recognized such as “temperature” and “turn up,” “route” and “search,” or “volume” and “turn up,” the voice recognition processor 11 may calculate the probability of connecting each of the series of words and may confirm the result of the recognition if the probability is high. When the result of the recognition is confirmed, the voice recognition processor 11 may output the result of the recognition to the control unit 3. Then, the control unit 3 may output the command based on the result of the recognition to the audio output control unit 18, the air conditioner control unit 32, and the like.

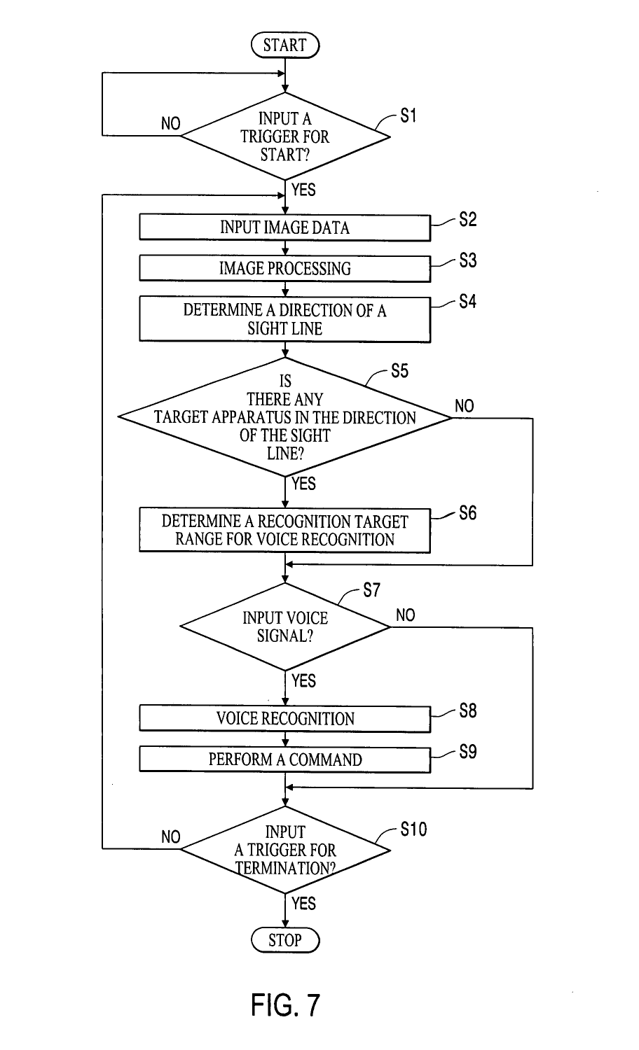

Next, an exemplary voice recognition method will be described below with reference to FIG. 7. The exemplary method may be implemented, for example, by one or more components of the above-described system. However, even though the exemplary structure of the above-described system may be referenced in the description, it should be appreciated that the structure is exemplary and the exemplary method need not be limited by any of the above-described exemplary structure.

As shown in FIG. 7, first, the control unit 3 stands by for the input of a trigger for starting the voice recognition process (S1). The trigger for starting the process may be an “on” signal outputted by the ignition of the vehicle; however, it may be a button for starting the voice recognition. When the trigger for starting the process is inputted (YES in S1), the image processor 9 inputs the image data corresponding to the filmed head of the driver D through the image signal input unit 10 (S2). Then the image processor 9 performs the image processing of the inputted image data and detects the position of the eyeball B of the driver D (S3).

The control unit 3 inputs the analyzed result through the image processor 9 and determines the direction of the sight line 14a of the driver D (S4). Then, it is determined whether a target apparatus 14b is in the direction of the sight line 14a based on, for example, the table of the target apparatus selection 14 shown in FIG. 5 (S5). For example, when the direction of the sight line 14a is “lower right,” the direction of the sight line 14a is associated with the target apparatus 14b “audio apparatus.” Therefore, the target apparatus 14b is determined to be in the sight line 14a (Yes in S5).

Next, the control unit 3 outputs the direction of sight line 14a to the voice recognition processor 11, and the voice recognition processor 11 determines the recognition target range from among the each of the recognition candidates 16a stored in the recognition dictionary 16 (S6). For example, when the target apparatus 14b “audio apparatus” is selected, each of the recognition candidates 16a associated with the target apparatus 14b “voice apparatus” become the recognition target.

The voice recognition processor 11 then determines whether any voice signal is inputted from the microphone 23 (S7). When no voice signals are inputted (NO in S7), operation jumps to S10. On the other hand, when some voice signal is inputted (YES in S7), the voice recognition processor 11 recognizes the voice (S8). As described above, the voice recognition processor 11 detects the feature amount of the voice signal and then calculates the phoneme series that are similar to the feature amount on the basis of the sound models 15. Each of the calculated phoneme series is collated with the recognition candidates 16a within the recognition target range set in S6 to select each of the similar recognition candidates 16a. When each of the recognition candidates 16a is determined, the probability of connecting relations for each of the recognition candidates 16a is calculated using the language models 17, subsequently the sentence having the great probability is confirmed as the result of the recognition.

When the result of the recognition is confirmed, the control unit 3 sends the command based on the result to the target apparatus 14b (S9). For example, when the target apparatus 14b is “air conditioner” and the result of the recognition is “hot,” the control unit 3 outputs the command to operate to lower the predetermined temperature to the air conditioner 38 through the vehicle-side I/F unit 7. In addition, when the target apparatus 14b is “audio apparatus” and the recognition result is “turn up the volume,” for example, the control unit 3 outputs the command to the audio output control unit 18 to turn up the volume. Further, when the target apparatus 14b is “navigation system” and the result of the recognition is “home,” for example, the control unit 3 searches the route from the current position of the vehicle to the pre-registered home with the route data 8a and the like, and outputs the searched route on the display 20.

On the other hand, if no target apparatus 14b associated with the direction of the sight line 14a are found (NO in S5), in S7, each of the recognition candidates 16a and each of the phoneme series are collated without determining the recognition target range from among the recognition candidates 16a in the recognition dictionary 16. Then the control unit 3 commands and controls the target apparatus 14b on the basis of the result of the voice recognition (S9).

When the command is performed, the control unit 3 determines whether the trigger for termination is inputted (S10). The trigger for termination may be the “off” signal of the ignition; however, it may be a button for termination. If there is no trigger for termination (NO in S110), the control unit 3 again starts to monitor the direction of the sight line 14a of the driver D (S2) and repeats the process of the voice recognition corresponding to the direction of the sight line 14a. thief there is a trigger for termination (YES in S110), the control unit 3 terminates the process.

Hereinafter, one or more advantages of the above examples are described.

The control unit 3 in the navigation system 1 determines the target apparatus 14b that locates the direction of the sight line of the driver D based on the analyzed result by the image processor 9. The voice recognition processor 11 sets each of the recognition candidates 16a associated with the determined target apparatus 14b as the recognition target range from among the recognition candidates 16a in the recognition dictionary 16. From the recognition target range, the recognition candidate 16a which is highly similar to the phoneme series based on the voice spoken by the driver D is confirmed as the result of the recognition. Therefore, not only the feature amount of the voice signals or the probability of connecting relations between a series of words, but also the detection of the target apparatus 14b may be used narrow down to the recognition candidate 16a. Therefore, there is a greater likelihood of matching what was spoken from among a huge number of recognition candidates 16a in the voice recognition DB 12.

Specifically, the recognition candidates 16a that are not corresponding to the determined target apparatus 14b may be excluded from the recognition target. Accordingly, an erroneous result may be avoided such as that a recognition candidate 16a that does not apply to the current situation of the driver D (e.g., is only related to an apparatus with which the driver is unconcerned) is confirmed due to a similar feature amount of the voice. Thus, setting the recognition target range may assist the process of the voice recognition so as to improve the accuracy of the recognition. Further, setting the recognition target range may eliminate the number of the recognition candidates 16a to collate with the phoneme series, and consequently may shorten the time for processing.

The image processor 9 detects the position of the eyeball B of the driver D on the basis of the image data inputted from the camera 22. Thereby, the direction of the sight line 14a of the speaker may be detected more accurately compared to the case of using infrared radar or the like for detecting the position of the eyeball.

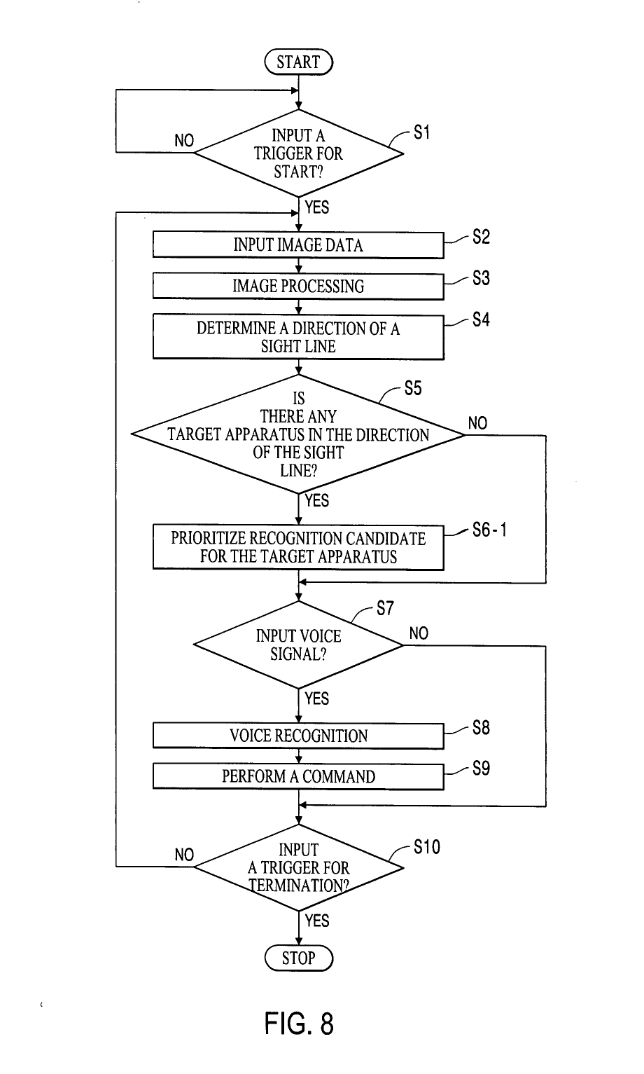

Next, an exemplary voice recognition method will be described below with reference to FIG. 8. The exemplary method may be implemented, for example, by one or more components of the above-described system. However, even though the exemplary structure of the above-described system may be referenced in the description, it should be appreciated that the structure is exemplary and the exemplary method need not be limited by any of the above-described exemplary structure.

Note that portions of this exemplary method are similar to the above described method, and thus the details of overlapping parts will be omitted accordingly.

Specifically, according to this example only the process in S6 is changed. In S5 shown in FIG. 8, when the target apparatus 14b is determined (YES in S5), the voice recognition processor 11 serving as a priority setting means prioritizes the recognition candidates 16a associated with the target apparatus 14b (S6-1). Specifically, the voice recognition processor 11 sets a probability score of the recognition candidates 16a associated with the target apparatus 14b higher. In the initial condition where the direction of the sight line 14a of the driver D is not detected (NO in S5), the probability score of each of the recognition candidates 16a is set by default or with the set value according to individual's frequency of the usage or with a set value according to general frequency of the usage and so forth. To set the probability score higher, a predetermined value may be added to the probability score, for example.

In S7, in case some voice signal is determined to be input (YES in S7), the voice recognition processor 11 recognizes the voice using the probability score (S8). That is to say, without narrowing down the recognition candidates 16a, the recognition candidates 16a, which have high probability score, are prioritized and confirmed when determining the similarity between each of the recognition candidates 16a and the phoneme series.

Hereinafter, additional advantages of this example are described.

The voice recognition processor 11 prioritizes each of the recognition candidates 16a for the target apparatus 14b corresponding to the direction of the sight line 14a of the driver D and performs the voice recognition. Thereby, the voice recognition processor 11 may determine the recognition candidates 16a, which have great probability to match the spoken voice without eliminating any recognition candidates. Accordingly, the voice may be recognized even when the direction of the sight line of the driver D is not associated with the contents of what was spoken.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

For example, the above examples may be modified as below.

As discussed above, the recognition candidates 16a in the recognition dictionary 16 and the target apparatus 14b may be associated. However, the language models 17 may be set to associate with the target apparatus 14b. For example, when the direction of the sight line 14a is associated with the target apparatus 14b “air conditioner,” the probability of the words relating to the operation of the air conditioner 38 such as “temperature,” “turn up,” or “turn down,” and the probability of connecting those words may be set higher than the default. The accuracy of recognition may improve accordingly.

As discussed above, an arrangement is made to set the probability score of the recognition candidates 16a associated with the target apparatus 14b in the direction of the sight line 14a higher. However, other arrangements may be made as long as prioritizing the recognition candidates 16a are prioritized. For example, the recognition candidates 16a associated with the target apparatus 14b in the direction of the sight line 14a may be collated first, and, if any recognition candidates with high similarity are not found, the recognition candidates 16a for other target apparatus 14b, with a lower priority, may be collated instead.

As discussed above, an arrangement is made wherein the image processor 9 monitors the changes of the sight line of the driver D and the voice recognition processor 11 stands by for input of a voice signal after inputting the trigger for starting the process. However, the sight line detection and the voice recognition may be arranged to start only when the driver presses a button. In this case, the trigger for starting the process may be the operation of pressing the start button by the driver D, and the trigger for the termination, for example, may be the operation of pressing the termination button by the driver or a timer which is a signal for indicating predetermined passage of time.

as discussed above, an arrangement may be made to pre-register the relationship between the direction of the sight line 14a or movement of the driver D and the target apparatus 14b. For example, a table may be registered wherein a movement of the driver to fan his/her face with his/her hand and the target apparatus 14b “air conditioner” may be associated, or the like. Then, when the image processor 9 serving as a movement detecting means detects the movement of the users hand fanning, the voice recognition processor 11 narrows down the recognition candidates 16a associated with the target apparatus 14b “air conditioner” as the recognition target range based on the table. Note that the table may be stored for each user.

In each embodiment, the air conditioner 38, the navigation system 1, the audio button 39 and so forth located around the driver D may be set as the target categories; however, other apparatuses may be set as the target categories. The relationship between the direction of the sight line 14a and the target apparatus 14b may vary according to the vehicle structure. In addition, the one direction of the sight line 14a may be associated with a plurality of target apparatuses 14b. For example, the direction of the sight line 14a “lower left” may be associated with the target apparatuses of the air conditioner 38 and the navigation system 1. Further, when the direction of the sight line 14a is any lefts including “left” or “lower left,” the target apparatuses may be all the apparatuses located on the left.

In the embodiment above, the voice recognition method and the voice recognition apparatus are applied to the navigation system 1 mounted in a vehicle. However, they may be applied to any other apparatuses having a voice recognition function such as a game, a robotic system, and so forth.

In the present invention, the visual target object assumed that the speaker is looking is detected and the recognition candidates corresponding to the visual target object are set as the recognition target range. Thus, the recognition candidate, which has great possibility to match the voice is narrowed down from among a huge number of recognition candidates, and the accuracy of the recognition improves accordingly.

What is claimed is:

1. A voice recognition apparatus for recognizing a voice spoken by a speaker comprising:
a recognition dictionary which stores groups of recognition candidates respectively associated with visual target objects located around the speaker;
a sight line detector that detects a direction of a sight line of the speaker; and
a controller that:
determines one of the visual target objects located in the direction of the sight line of the speaker on the basis of the direction of the sight line;
from among the recognition candidates in the recognition dictionary, sets each of the recognition candidates associated with the determined visual target object as a recognition target range; and
from among the recognition target range, selects a recognition candidate which is highly similar to voice data inputted by a microphone.

2. The voice recognition apparatus according to claim 1, wherein:
the determined visual target object is a control target apparatus mounted in a vehicle; and
the controller outputs a control signal to the control target apparatus on the basis of the selected recognition candidate.

3. The voice recognition apparatus according to claim 1, wherein the controller:
inputs image data from a camera;
processes the image data; and
calculates the direction of the sight line of the speaker.

4. The voice recognition apparatus according to claim 3, wherein:
the camera captures image data of the speaker's eyes; and
the controller calculates the direction of the sight line of the speaker based on the orientation of the speaker's eyes.

5. A voice recognition apparatus for recognizing a voice spoken by a speaker, comprising:
a recognition dictionary which stores groups of recognition candidates respectively associated with visual target objects located around the speaker;
a sight line detector that detects a direction of a sight line of the speaker; and
a controller that:
determines one of the visual target objects located in the direction of the sight line of the speaker on the basis of the direction of the sight line;
sets higher priority on the visual target object located in the direction of the sight line of the speaker; and
from among the recognition candidates in the recognition dictionary, selects the recognition candidate which is highly similar to voice data inputted by a microphone on the basis of the set priority.

6. The voice recognition apparatus according to claim 5, wherein:
the determined visual target object is a control target apparatus mounted in a vehicle; and
the controller outputs a control signal to the control target apparatus on the basis of the selected recognition candidate.

7. The voice recognition apparatus according to claim 5, wherein the controller:
inputs image data from a camera;
processes the image data; and
calculates the direction of the sight line of the speaker.

8. The voice recognition apparatus according to claim 7, wherein:
the camera captures image data of the speaker's eyes; and
the controller calculates the direction of the sight line of the speaker based on the orientation of the speaker's eyes.

9. A voice recognition apparatus for recognizing a voice spoken by a speaker, comprising:
a recognition dictionary which stores groups of recognition candidates respectively associated with visual target objects located around the speaker;
a movement detector that detects a movement of the speaker; and
a controller that:
selects a category associated with the movement of the speaker and determines one of the visual target objects on the basis of the selected category;
sets the each of the recognition candidates associated with the visual target object as a recognition target range; and
from among the recognition target range, selects a recognition candidate which is highly similar to voice data inputted by a microphone.

10. The voice recognition apparatus according to claim 9, wherein:
the determined visual target object is a control target apparatus mounted in a vehicle; and
the controller outputs a control signal to the control target apparatus on the basis of the selected recognition candidate.

11. The voice recognition apparatus according to claim 9, wherein the controller:
inputs image data from a camera;
processes the image data; and
calculates the movement of the speaker.

12. A voice recognition method for recognizing a voice spoken by a speaker, comprising:
detecting a direction of a sight line of the speaker;
predicting a visual target object located in the direction of the sight line;
setting each of a plurality of recognition candidates corresponding to the predicted visual target object as a recognition target range;
from among the recognition target range, selecting a recognition candidate which is highly similar to the voice spoken by the speaker.

13. The voice recognition method according to claim 12, further comprising:
inputting image data from a camera;
processing the image data; and
calculating the direction of the sight line of the speaker.

14. The voice recognition method according to claim 12, wherein the predicted visual target object is a control target apparatus mounted in a vehicle, the method further comprising:
outputting a control signal to the control target apparatus on the basis of the selected recognition candidate.
